(19) United States
(12) Patent Application Publication
(10) Pub. No.: US 2014/0159579 A1
(43) Pub. Date: Jun. 12, 2014

(54) LIGHTING MODULE AND LIGHTING APPARATUS USING LIGHTING MODULE

(71) Applicant: Samsung Electronics Co., Ltd., Suwon-si (KR)

(72) Inventor: HYE JUNG SEOL, Seoul (KR)

(73) Assignee: Samsung Electronics Co., Ltd., Suwon-si (KR)

(21) Appl. No.: 13/966,630

(22) Filed: Aug. 14, 2013

(30) Foreign Application Priority Data
Dec. 11, 2012 (KR) 10-2012-0143412

(51) Int. Cl. H05B 33/08

(52) U.S. Cl. CPC H05B 33/0809
USPC 315/85; 315/200 R; 315/201; 315/113

(57) ABSTRACT

A lighting module includes a power reception unit configured to receive alternating current (AC) power from an external power source, a light emitting diode (LED) array including a plurality of LEDs, and a driving circuit unit configured to supply operational power to the plurality of LEDs, and control operation of the plurality of LEDs.

### CROSS-REFERENCE TO RELATED APPLICATIONS

This application claims priority under 35 U.S.C. §119 to Korean Patent Application No. 10-2012-0143412, filed on Dec. 11, 2012, the disclosure of which is incorporated by reference herein in its entirety.

### TECHNICAL FIELD

The present invention relates to a lighting module and a lighting apparatus using the lighting module.

### DISCUSSION OF THE RELATED ART

Light emitting diode (LED) lighting provides certain benefits over other types of lighting. For example, LED lighting may be environmentally friendly and may result in reduced energy consumption. As a result, the use of LED lighting throughout the world is increasing.

LED lighting devices include a power supply unit (PSU) adapted to supply operational power to the LED unit of the LED lighting device. In addition, the PSU may include a dimming function for adjusting the luminance of the LED lighting device, and may further include an independent LED control function.

About 75% of defects of LED lighting devices relate to defects in the PSU. Since the PSU in an LED lighting device is difficult to replace, when the PSU has a defect, the entire LED lighting device may need to be discarded. In addition, a defective PSU may result in the overheating or explosion of the LED lighting device.

### SUMMARY

According to an exemplary embodiment of the present invention, a lighting module includes a power reception unit configured to receive alternating current (AC) power from an external power source, a light emitting diode (LED) array including a plurality of LEDs, and a driving circuit unit configured to supply operational power to the plurality of LEDs, and control operation of the plurality of LEDs.

The driving circuit unit may be configured to receive the AC power from the power reception unit and supply the AC power to the plurality of LEDs as the operational power.

The lighting module may further include a power conversion circuit unit configured to convert the AC power from the external power source to direct current (DC) power, wherein the driving circuit unit is configured to receive the DC power from the power conversion circuit unit and supply the DC power to the plurality of LEDs as the operational power.

The power reception unit, the LED array, the power conversion circuit unit, and the driving circuit unit may be disposed on a printed circuit board (PCB).

The driving circuit unit may include a control module configured to control an on state and an off state of the plurality of LEDs by supplying the plurality of LEDs with the operational power, control a luminance of the plurality of LEDs according to a dimming signal received by the driving circuit, and maintain a constant level of the operational power supplied to the plurality of LEDs.

The driving circuit unit may further include a power variation unit configured to vary a level of the AC power received from the power reception unit to be equal to a level of a reference power of the lighting module upon determining that the level of the received AC power is different from the level of the reference power.

The driving circuit unit may further include a total harmonic distortion (THD) prevention circuit unit configured to compensate for THD.

The power reception unit may include a connection port configured to detachably connect to an external electrical connector.

According to an exemplary embodiment of the present invention, a lighting apparatus includes at least one lighting module. The at least one lighting module includes a power reception unit configured to receive alternating current (AC) power from an external power source, a light emitting diode (LED) array including a plurality of LEDs, and a driving circuit unit configured to supply operational power to the plurality of LEDs, and control operation of the plurality of LEDs. The lighting apparatus further includes a housing configured to receive the at least one lighting module.

The driving circuit unit may be configured to receive the AC power from the power reception unit and supply the AC power to the plurality of LEDs as the operational power.

The lighting apparatus may further include a power conversion circuit unit configured to convert the AC power from the external power source to direct current (DC) power, wherein the driving circuit unit is configured to receive the DC power from the power conversion circuit unit and supply the DC power to the plurality of LEDs as the operational power.

The driving circuit unit may include a control module configured to control an on state and an off state of the plurality of LEDs by supplying the plurality of LEDs with the operational power, control a luminance of the plurality of LEDs according to a dimming signal received by the driving circuit unit, and maintain a constant level of the operational power supplied to the plurality of LEDs.

The driving circuit unit may further include a power variation unit configured to vary a level of the AC power received from the power reception unit to be equal to a level of a reference power of the lighting module upon determining that the level of the received AC power is different from the level of the reference power.

The driving circuit unit may further include a total harmonic distortion (THD) prevention circuit unit configured to compensate for THD.

The housing may be electrically connected to the at least one lighting module, and is configured to transmit the AC power from the external power source to the at least one lighting module.

The housing may include a heat sink configured to radiate heat generated by the LED array.

According to an exemplary embodiment of the present invention, a lighting module includes a printed circuit board (PCB), a power reception unit including a connection port and configured to receive alternating current (AC) power from an external power source via the connection port, wherein the connection port is disposed on an edge of the PCB and is configured to detachably connect to an external electrical connector, a light emitting diode (LED) array disposed on an upper surface of the PCB and including a plurality of LEDs, wherein the upper surface of the PCB is adjacent to the edge of the PCB, and a driving circuit unit disposed on the upper surface of the PCB and configured to supply operational power to the plurality of LEDs, and control operation of the plurality of LEDs.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram illustrating a configuration of a lighting module, according to an exemplary embodiment of the present invention.

FIG. 2 is a block diagram illustrating a configuration of a lighting module, according to an exemplary embodiment of the present invention.

FIG. 3 is a perspective view illustrating the configuration of the lighting module of FIG. 2, according to an exemplary embodiment of the present invention.

FIGS. 4 to 6 are perspective views illustrating lighting apparatuses employing a lighting module according to exemplary embodiments of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to the like elements throughout the accompanying drawings.

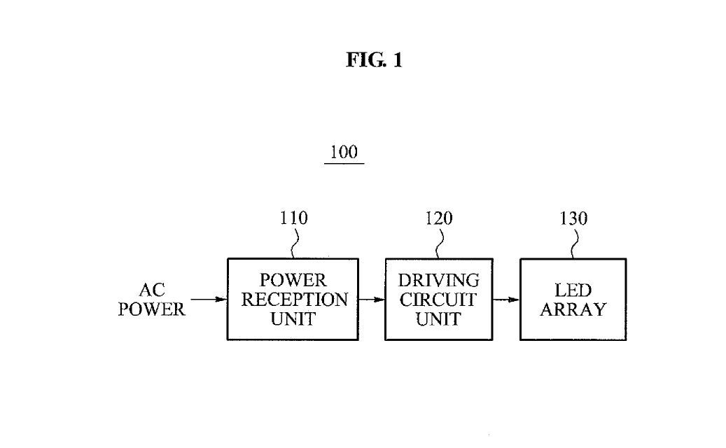

FIG. 1 is a block diagram illustrating a configuration of a lighting module 100, according to an exemplary embodiment of the present invention.

Referring to FIG. 1, the lighting module 100 may include a power reception unit 110, a driving circuit unit 120, and a light emitting diode (LED) array 130.

The power reception unit 110 receives power from a power source external to the lighting module (e.g., power from a commercially available power source located external to the lighting module 100). The power may be, for example, alternating current (AC) power received from an AC power source.

The LED array 130 may include, for example, a plurality of LEDs. The plurality of LEDs are driven by the power source.

The driving circuit unit 120 supplies operational power to the plurality of LEDs to allow for the operation of the LEDs, and further controls the operation of the plurality of LEDs. For example, the driving circuit unit 120 may supply the AC power received from the power reception unit 110 to the plurality of LEDs as the operational power to allow for the operation of the LEDs.

The lighting module 100 shown in FIG. 1 may supply the AC power received from the external power source directly to the plurality of LEDs of the LED array 130. Therefore, the lighting module 100 shown in FIG. 1 may not be required to perform a conversion of the received AC power to direct current (DC) power, and thus, may not include a power supply unit (PSU). Therefore, the lighting module 100 may be driven using a commercially available standardized power system operated by AC power.

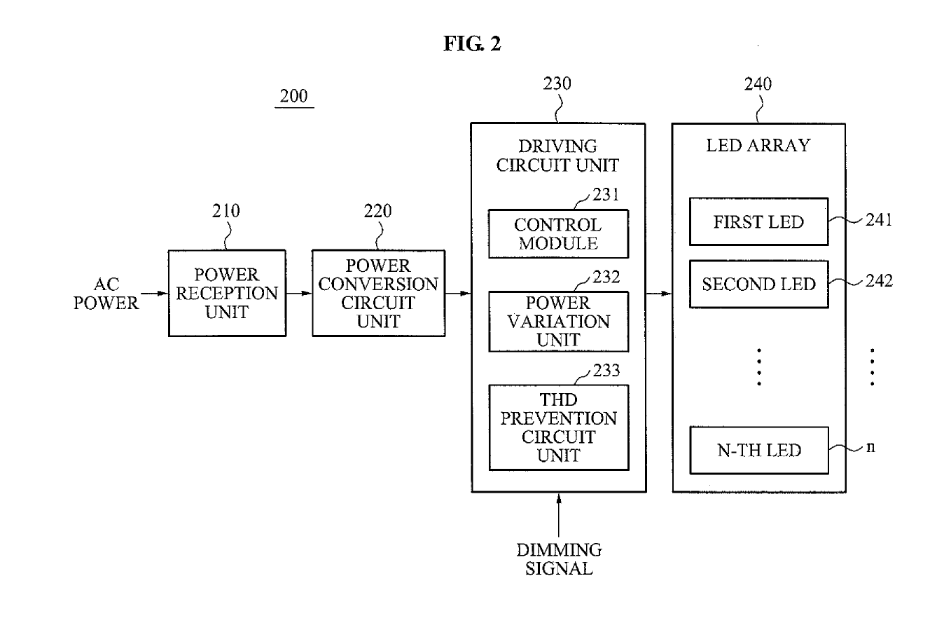

FIG. 2 is a block diagram illustrating a configuration of a lighting module 200 according to an exemplary embodiment of the present invention. Referring to FIG. 2, the lighting module 200 may include a power reception unit 210, a power conversion circuit unit 220, a driving circuit unit 230, and an LED array 240 that includes a plurality of LEDs 241, 242, . . . , n.

The power reception unit 210, the power conversion circuit unit 220, the driving circuit unit 230, and the plurality of LEDs 241, 242, . . . , n may be provided on a printed circuit board (PCB). The PCB may be formed according to the global Zhaga standard, and may have a bar structure or a square structure. However, the PCB is not limited thereto, may be formed according to various other standards, and may have various other shapes and structures.

The plurality of LEDs 241, 242, . . . , n may be mounted on a separate substrate and connected to the PCB, or may be directly connected to the PCB. The plurality of LEDs 241, 242, . . . , n may be connected serially or in parallel.

The power reception unit 210 may receive AC power from an external power source. The power reception unit 210 may include a connection port allowing for the detachable connection to an external electrical connector.

The power conversion circuit unit 220 converts the AC power supplied from the external power source to DC power. The power conversion circuit unit 220 may be, for example, a bridge rectifying circuit, and may provide the DC power to be supplied to the plurality of LEDs 241, 242, . . . , n of the LED array 240.

The driving circuit unit 230 receives the DC power from the power conversion circuit unit 220, supplies the DC power to the plurality of LEDs 241, 242, . . . , n, and controls the operation of the plurality of LEDs 241, 242, . . . , n. The driving circuit unit 230 may include, for example, a control module 231, a power variation unit 232, and/or a total harmonic distortion (THD) prevention circuit unit 233, which are described in further detail below. In an exemplary embodiment, the driving circuit unit 120 of FIG. 1 may be replaced with the driving circuit unit 230 of FIG. 2, including the control module 231, the power variation unit 232, and/or the THD prevention circuit unit 233. This driving circuit unit 120 may receive AC power from the power reception unit 110, and may also receive and utilize a dimming signal, as described below.

The control module 231 controls the operation of the plurality of LEDs 241, 242, . . . , n. For example, the control module 231 may supply the operational power to the plurality of LEDs 241, 242, . . . , n, thereby controlling on and off states of the plurality of LEDs 241, 242, . . . , n. The control module 231 may control the on and off states by supplying or interrupting the operational power with respect to the plurality of LEDs 241, 242, . . . , n according to the status of the power conversion circuit unit 220. For example, the control module 231 may control the on and off states of the plurality of LEDs 241, 242, . . . , n according to whether the DC power is supplied from the power conversion circuit unit 220 (e.g., the plurality of LEDs 241, 242, . . . , n may be turned on when DC power is supplied from the power conversion circuit unit 220, and may be turned off when DC power is not supplied from the power conversion circuit unit 220.

The control module 231 may control luminance by controlling the power supplied to the plurality of LEDs 241, 242, . . . , n according to a dimming signal received by the driving circuit unit 230. The dimming signal may be supplied from an external source, or generated by a dimmer or dimming circuit provided in the lighting module 200.

The control module 231 may reduce flickering by maintaining a constant level of the operational power supplied to the plurality of LEDs 241, 242, . . . , n.

The control module 231 may supply the operational power to the plurality of LEDs 241, 242, . . . , n together or independently.

The power variation unit 232 varies the power received from the power reception unit 210. For example, when a level of the power received from the power reception unit 210 is different from a level of a reference power of the lighting module 200, the power variation unit 232 may vary the level of the power to be equal to, or substantially equal to, the level of the reference power.

The reference power of the lighting module 200 may refer to a standard commercially available level of AC power, which may be used for operation of the lighting module 200. For example, the reference power of the lighting module 200 may be about 110V or about 220V, however, the reference power is not limited thereto.

For example, according to an exemplary embodiment, when the reference power of the lighting module 200 is about 110V, and the AC power received from the power reception unit 210 is about 220V, the power variation unit 232 may vary the AC power of about 220V to the AC power of about 110V.

If the level of the power received from the power reception unit 210 is different from the level of the reference power, the received power may be varied to a usable power level in the lighting module 200 by the power variation unit 232. As a result, the lighting module 200 may be used with a variety of commercially available external power sources, such as, for example, power sources outputting 110V and 220V. However, exemplary embodiments are not limited to utilizing external power sources outputting 110V and 220V, and may be utilized with any commercially available external power sources.

The THD prevention circuit unit 233 may compensate for THD. For example, the THD prevention circuit unit 233 may compensate harmonic distortion components so that harmonic distortion is not present in the operational power supplied to the LED array 240.

The lighting module 200 shown in FIG. 2 may convert the received commercially available AC power to DC power using rectification, and may supply the DC power to the plurality of LEDs 241, 242, . . . , n through the control module 231. As a result, the lighting module 200 may function without the inclusion of a PSU.

The lighting module 200 that does not include a PSU, according to exemplary embodiments, may operate by directly receiving AC power. Therefore, the lighting module 200 may be driven using a commercially available standardized power system operated by AC power.

The omission of a PSU from the lighting module 200, according to exemplary embodiments of the present invention, may result in the reduction of the cost and size of the lighting module 200.

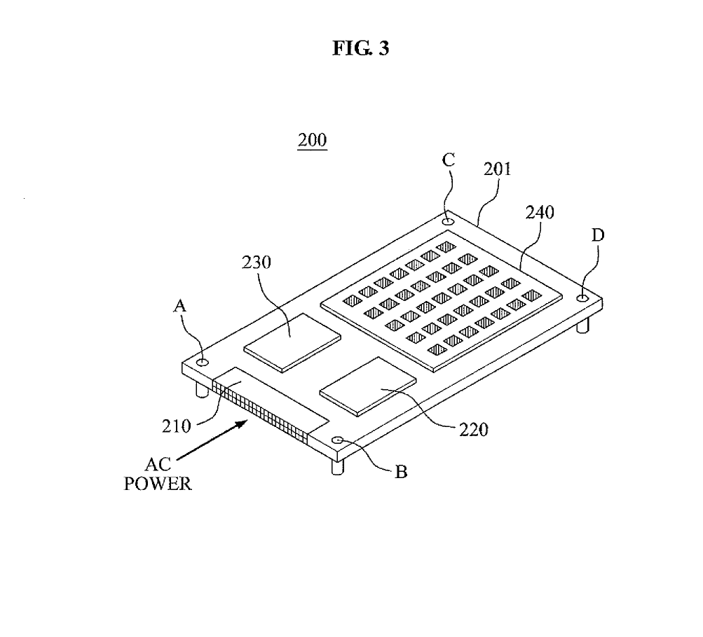

FIG. 3 is a perspective view showing a configuration of the lighting module 200 shown in FIG. 2, according to an exemplary embodiment of the present invention.

Referring to FIG. 3, the lighting module 200 may include the power reception unit 210, the power conversion circuit unit 220, the driving circuit unit 230, and the LED array 240.

The power reception unit 210 may receive commercially available AC power from an external power source. The power reception unit 210 may include a connection port allowing for the detachable connection to an external electrical connector.

The power conversion circuit unit 220 may convert the AC power received from the power reception unit 210 to DC power through rectification.

The driving circuit unit 230 may receive the DC power from the power conversion circuit unit 220, and may supply the operational power to the plurality of LEDs of the LED array 240, and control the operation of the plurality of LEDs of the LED array 240.

For example, as described with reference to FIG. 2, the driving circuit unit 230 may control on and off states of the LEDs of the LED array 240 by supplying the operational power to the plurality of LEDs through a control module, and control luminance by controlling the operational power supplied to the plurality of LEDs according to a dimming signal. The driving circuit unit 230 may maintain a constant level of power supplied to the plurality of LEDs, which may reduce flickering.

In addition, as described with reference to FIG. 2, the driving circuit unit 230 may compare the power received from the power reception unit 210 with the reference power of the lighting module 200 using a power variation unit. When the two power levels are different, the driving circuit unit 230 may vary the power received from the power reception unit 210 to be equal to, or substantially equal to, the reference power.

As described with reference to FIG. 2, the driving circuit unit 230 may compensate for THD using a THD prevention circuit unit.

The LED array 240 may include a plurality of LEDs arranged in a matrix form on a PCB 201. The plurality of LEDs may be controlled by a control module of the driving circuit unit 230 together or independently, and may be supplied with the operational power together or independently.

The PCB 201 may be standardized according to the global Zhaga standard, and may have, for example, a bar type structure. However, the structure of the PCB 201 is not limited thereto. The PCB 201 may include connection projections A, B, C, and D at four corners. The connection projections A, B, C, and D may be configured for coupling with connection recesses of a lighting apparatus such as, for example, a street lamp or a fluorescent lamp. That is, the PCB 201 may be connected to the lighting apparatus via the connection projections A, B, C, and D.

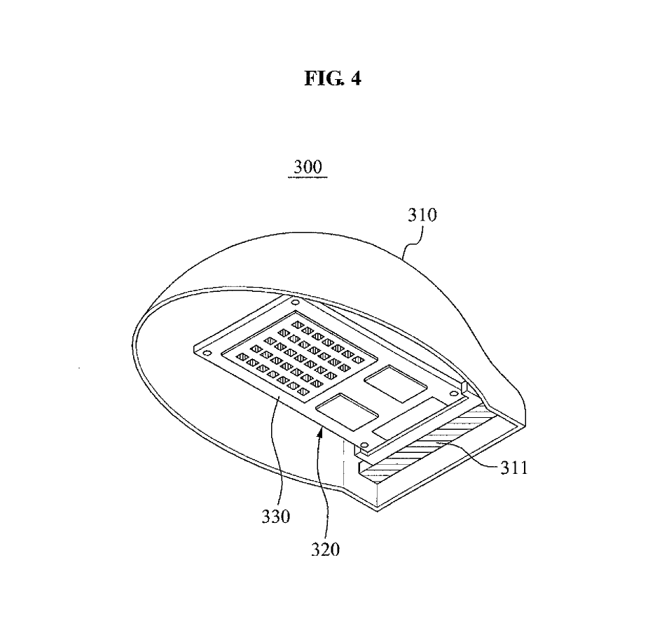

The configuration of the lighting module 200 in FIG. 3 allows for the convenient attachment and detachment of the lighting module 200 to and from various lighting apparatuses, as described further with reference to FIGS. 4 to 6. For example, the lighting module 200 may be physically attached to and detached from a lighting apparatus via the connection projections A, B, C, and D, and may be electrically coupled to and decoupled from a lighting apparatus via the connection port of the power reception unit 210. The location of the power reception unit 210 and the LED array 240 allows the lighting module 200 to be conveniently attached to and detached from a lighting apparatus, as shown in FIGS. 4 to 6. For example, as shown in FIG. 3, the connection port of the power reception unit 210 may be disposed on an edge of the lighting module 200, and the LED array 240, the driving circuit unit 230, and the power conversion circuit unit 220 may be disposed on an upper surface of the lighting module 200, adjacent to the edge. This allows for the lighting module 200 to be conveniently disconnected from a lighting apparatus, and for a new lighting module 200 to be conveniently attached to the lighting apparatus when replacement of the lighting module 200 is needed.

Although FIG. 3 shows the configuration of the lighting module 200 of FIG. 2 according to an exemplary embodiment, the lighting module 100 of FIG. 1 may be configured in a similar manner. For example, the power conversion unit 220 may be removed from FIG. 3 according to a configuration based on the lighting module 100 of FIG. 1.

FIGS. 4 to 6 are perspective views illustrating a lighting apparatus employing a lighting module, according to exemplary embodiments of the present invention. The lighting apparatuses shown in FIGS. 4 to 6 may include either of the lighting modules 100 and 200 of FIGS. 1 and 2 mounted thereon. Thus, the lighting apparatuses of FIGS. 4 to 6 are provided with a lighting module operated using commercially available AC power, and may be driven using a standardized driving method that utilizes commercially available AC power, without the use of a PSU in the lighting module.

FIG. 4 illustrates a lighting apparatus 300 of a street lamp type, which is provided with the lighting module 100 or 200 of FIGS. 1 and 2. Referring to FIG. 4, the lighting apparatus 300 for a street lamp may include a street lamp housing 310 and a lighting module 320. As described above, the lighting module 320 may be the lighting module 100 or 200 shown in FIGS. 1 and 2.

The street lamp housing 310 may include a mounting space for mounting the lighting module 320. In the mounting space, an electrical connector 311 may be provided for the detachable connection of a power reception unit included in the lighting module 320. The electrical connector 311 may transmit AC power from an external power source to the lighting module 320. An internal portion of the mounting space may be coated with a reflective material to reflect light generated from the lighting module 320.

The lighting module 320 may be mounted in the mounting space of the street lamp housing 310 and may operate using commercially available AC power.

The lighting apparatus 300 for a street lamp uses the lighting module 320 capable of operating using commercially available AC power without a separate PSU. The lighting apparatus 300 for a street lamp may be driven using a standardized driving system operated by AC power, and may control the operation of the LEDs through a control module, as described with reference to FIG. 2.

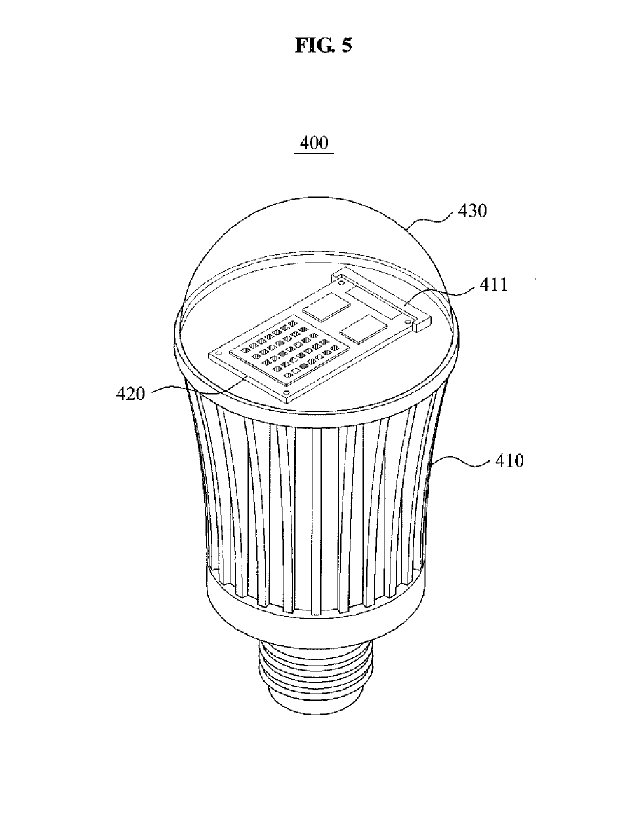

FIG. 5 illustrates a lighting apparatus 400 for a bulb, which is provided with the lighting module 100 or 200 of FIGS. 1 and 2. Referring to FIG. 5, the lighting apparatus 400 for a bulb may include a bulb housing 410, a lighting module 420, and a lens 430. As described above, the lighting module 420 may be the lighting module 100 or 200 shown in FIGS. 1 and 2.

The bulb housing 410 may be, for example, a heat sink adapted to radiate heat generated from an LED array included in the lighting module 420.

The bulb housing 410 may include an electrical connector 411 disposed in a region for mounting the lighting module 420. The electrical connector 411 may be configured to allow the power reception unit of the lighting module 420 to be detachably connected to the bulb housing 410. The detachable connection provided via the electrical connector 411 enables convenient replacement of the lighting module 420 when needed.

The lens 430 may be mounted on a light emission surface of the bulb housing 410, and may protect the lighting module 420 from external elements and increase light emission.

The lighting apparatus 400 for a bulb uses the lighting module 420 capable of operating using commercially available AC power, without the inclusion of a separate PSU in the lighting apparatus 400, as described above, according to exemplary embodiments. Therefore, the lighting apparatus 400 for a bulb may be driven using a standardized driving system operated by AC power, and may control the operation of the LEDs through the control module of the lighting module 420.

Utilization of the lighting apparatus 400 for a bulb using the lighting module 420 including the LED array, according to exemplary embodiments of the present invention, may improve energy efficiency of the lighting apparatus 400 for a bulb compared to other lighting apparatuses such as, for example, a high intensity discharge (HID) lamp.

In addition, since the lighting module 420 may use a PCB according to the global Zhaga standard, the lighting module 420 may be standardized and may be conveniently used in a variety of applications.

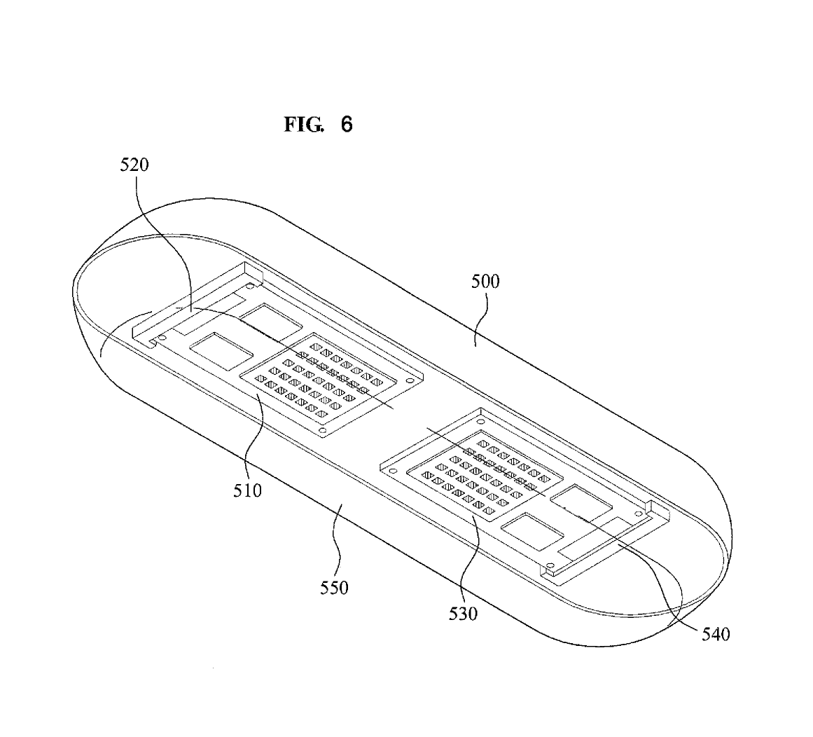

FIG. 6 illustrates a lighting apparatus to which the lighting module according to exemplary embodiments of the present invention may be mounted. Referring to FIG. 6, the lighting apparatus may include a fluorescent lamp housing 500, first and second lighting modules 510 and 530, and a lens 550. The first and second lighting modules 510 and 530 may be the lighting module 100 or 200 shown in FIGS. 1 and 2.

The fluorescent lamp housing 500 may include first and second electrical connectors 520 and 540 disposed in regions for mounting the first and second lighting modules 510 and 530. The first and second electrical connectors 520 and 540 may be configured to allow the power reception units of the first and second lighting modules 510 and 530 to be detachably connected to the fluorescent lamp housing 500. That is, the first and second lighting modules 510 and 530 may be conveniently connected to and disconnected from the first and second electrical connectors 520 and 540.

Although FIG. 5 shows two lighting modules mounted in the fluorescent lamp housing 500, exemplary embodiments are not limited thereto. For example, the fluorescent lamp housing 500 may be configured to allow for the mounting of one lighting module, or three or more lighting modules. The lighting modules may include any combination of the lighting module 100 and 200 shown in FIGS. 1 and 2.

The lens 550 may be mounted on a light emission surface of the fluorescent lamp housing 500, and may protect the first and second lighting modules 510 and 530 from external elements and increase light emission.

The fluorescent lamp housing 500 including the first and second lighting modules 510 and 530 capable of operating using commercially available AC power, which each do not include a separate PSU, may be driven using a standardized driving system operated by AC power, and may control the operation of the LEDs through the control modules of the first and second lighting modules 510 and 530.

As described above, the lighting modules and lighting apparatuses using the lighting modules, according to exemplary embodiments of the present invention, may control the operation of a plurality of LEDs using commercially available AC power received from a standard external source. Since the lighting modules and lighting apparatuses are capable of directly using the commercially available AC power, a PSU may be omitted from the lighting modules and lighting apparatuses, which may reduce the cost and size of the lighting modules and lighting apparatuses. The lighting modules and lighting apparatuses may be used in various lighting products, including the lighting products described with reference to FIGS. 4 to 6. Further, utilization of the lighting modules and lighting apparatuses are not limited to the lighting products described with reference to FIGS. 4 to 6.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A lighting module, comprising:
a power reception unit configured to receive alternating current (AC) power from an external power source;
a light emitting diode (LED) array comprising a plurality of LEDs; and
a driving circuit unit configured to supply operational power to the plurality of LEDs, and control operation of the plurality of LEDs.

2. The lighting module of claim 1, wherein the driving circuit unit is configured to receive the AC power from the power reception unit and supply the AC power to the plurality of LEDs as the operational power.

3. The lighting module of claim 1, further comprising:
a power conversion circuit unit configured to convert the AC power from the external power source to direct current (DC) power,
wherein the driving circuit unit is configured to receive the DC power from the power conversion circuit unit and supply the DC power to the plurality of LEDs as the operational power.

4. The lighting module of claim 3, wherein the power reception unit, the LED array, the power conversion circuit unit, and the driving circuit unit are disposed on a printed circuit board (PCB).

5. The lighting module of claim 1, wherein the driving circuit unit comprises:
a control module configured to control an on state and an off state of the plurality of LEDs by supplying the plurality of LEDs with the operational power, control a luminance of the plurality of LEDs according to a dimming signal received by the driving circuit unit, and maintain a constant level of the operational power supplied to the plurality of LEDs.

6. The lighting module of claim 5, wherein the driving circuit unit further comprises:
a power variation unit configured to vary a level of the AC power received from the power reception unit to be equal to a level of a reference power of the lighting module upon determining that the level of the received AC power is different from the level of the reference power.

7. The lighting module of claim 5, wherein the driving circuit unit further comprises:
a total harmonic distortion (THD) prevention circuit unit configured to compensate for THD.

8. The lighting module of claim 1, wherein the power reception unit comprises:
a connection port configured to detachably connect to an external electrical connector.

9. A lighting apparatus, comprising:
at least one lighting module comprising:
a power reception unit configured to receive alternating current (AC) power from an external power source,
a light emitting diode (LED) array comprising a plurality of LEDs, and
a driving circuit unit configured to supply operational power to the plurality of LEDs, and control operation of the plurality of LEDs; and
a housing configured to receive the at least one lighting module.

10. The lighting apparatus of claim 9, wherein the driving circuit unit is configured to receive the AC power from the power reception unit and supply the AC power to the plurality of LEDs as the operational power.

11. The lighting apparatus of claim 9, further comprising:
a power conversion circuit unit configured to convert the AC power from the external power source to direct current (DC) power,
wherein the driving circuit unit is configured to receive the DC power from the power conversion circuit unit and supply the DC power to the plurality of LEDs as the operational power.

12. The lighting apparatus of claim 9, wherein the driving circuit unit comprises:
a control module configured to control an on state and an off state of the plurality of LEDs by supplying the plurality of LEDs with the operational power, control a luminance of the plurality of LEDs according to a dimming signal received by the driving circuit unit, and maintain a constant level of the operational power supplied to the plurality of LEDs.

13. The lighting apparatus of claim 12, wherein the driving circuit unit further comprises:
a power variation unit configured to vary a level of the AC power received from the power reception unit to be equal to a level of a reference power of the lighting module upon determining that the level of the received AC power is different from the level of the reference power.

14. The lighting apparatus of claim 12, wherein the driving circuit unit further comprises:
a total harmonic distortion (THD) prevention circuit unit configured to compensate for THD.

15. The lighting apparatus of claim 9, wherein the housing is electrically connected to the at least one lighting module, and is configured to transmit the AC power from the external power source to the at least one lighting module.

16. The lighting apparatus of claim 9, wherein the housing comprises a heat sink configured to radiate heat generated by the LED array.

17. A lighting module, comprising:
a printed circuit board (PCB);
a power reception unit comprising a connection port and configured to receive alternating current (AC) power from an external power source via the connection port,
wherein the connection port is disposed on an edge of the PCB and is configured to detachably connect to an external electrical connector;
a light emitting diode (LED) array disposed on an upper surface of the PCB and comprising a plurality of LEDs, wherein the upper surface of the PCB is adjacent to the edge of the PCB; and
a driving circuit unit disposed on the upper surface of the PCB and configured to supply operational power to the plurality of LEDs, and control operation of the plurality of LEDs.

18. The lighting module of claim 17, further comprising:
at least one connection projection disposed on the PCB and configured to couple to a connection recess of a lighting apparatus,
wherein the lighting apparatus comprises the external electrical connector and a lens covering the lighting module.

19. The lighting module of claim 17, wherein the driving circuit unit is configured to receive the AC power from the power reception unit and supply the AC power to the plurality of LEDs as the operational power.

20. The lighting module of claim 17, further comprising:
a power conversion circuit unit configured to convert the AC power from the external power source to direct current (DC) power,
wherein the driving circuit unit is configured to receive the DC power from the power conversion circuit unit and supply the DC power to the plurality of LEDs as the operational power.
